(19) United States
(12) Patent Application Publication
(10) Pub. No.: US 2010/0282015 A1
(43) Pub. Date: Nov. 11, 2010

(54) SHIFTING DEVICE

(75) Inventor: Dirk Lude, Munchen (DE)

Correspondence Address: VOLPE AND KOENIG, P.C., UNITED PLAZA, 30 SOUTH 17TH STREET, PHILADELPHIA, PA, 19103, US

(73) Assignee: GUSTAV MAGENWIRTH GMBH & CO. KG, Bad Urach (DE)

(21) Appl. No.: 12/863,469

(22) PCT Filed: Jan. 15, 2009
(86) PCT No.: PCT/EP09/00208

§ 371 Date: Jul. 19, 2010

(30) Foreign Application Priority Data
Jan. 23, 2008 (DE) 102008005627.8

(51) Int. Cl. B62M 25/00

(52) U.S. Cl. 74/491

(57) ABSTRACT

A shifting device, particularly for bicycle gearshifts, having an attachment device (2) for the installation of the shifting device on a handle bar (3) or similar steering unit, and having a shifting lever (10) for manual operation. The shifting device has a single shifting lever (10) for both shifting directions. The shifting lever (10) is pivotally supported about two different axes (6, 15), and one shifting direction is associated with each pivot axis (6, 15).

### BACKGROUND

The invention relates to a shifting device, in particular, for bicycle gearshifts, with an attachment device for installation of the shifting device on a handlebar or a similar steering unit and with a shifting lever for manual activation.

Bicycles or other muscle-powered vehicles often have at least one gearshift that is controlled by a shifting device.

Known shifting devices have, for this purpose, for example, a shifting lever for upshifting and a second shifting lever for downshifting. Here, for shifting, at least one finger must be released more or less from the handlebar, wherein the grip around the handlebar is loosened. Therefore, the rider no longer has complete control over the bicycle, which can be problematic, especially in open country.

A combination braking and shifting lever is also known in which, for shifting, the braking lever can be pivoted about an additional axis. However, for this arrangement, a second shifting lever is also provided for the other shifting direction. Among other things, the shifting is here problematic during the braking, because an additional pivoting motion can be performed with tightened fingers only with difficulty.

Another known shifting device provides a shifting lever that can be manipulated only in one direction and the shifting direction is defined by the length of the shifting path. Here, however, it is difficult to find the boundary between upshifting and downshifting, especially for uneven routes, so that incorrect shifting cannot be ruled out.

### SUMMARY

Therefore, the objective of the invention is to create a shifting device that has a unique shifting function and that can be operated ergonomically in all driving situations.

This objective is met in that a single shifting lever is provided for both shifting directions, the shifting lever is supported so that it can pivot about two different axes, and one shifting direction is allocated to each pivot axis.

Because only one shifting lever is necessary, this can be arranged in the optimal ergonomic position on the handlebar, so that good handling is achieved. Preferably, the shifting lever is arranged so that, for shifting, the grip around the handlebar does not have to be loosened. This gives better control over the bicycle and higher riding safety.

Preferably, the shifting lever is arranged so that it is arranged on the handlebar in the direction of travel and one shifting direction can be operated with the thumb and the other shifting direction can be operated with the index finger. Therefore, during shifting, the handlebar can be held completely. In addition, it is possible to brake while shifting, because sufficient braking pressure can be applied with one finger at least in modern hydraulic disk brakes. Thus, it is possible to maintain control in any riding situation and to shift gears safely.

Although the shifting lever advantageously can be operated with the thumb and index finger, the shifting lever could also be operated with fingers other than those mentioned or even with only one finger.

By separating the shifting directions to two different pivot axes and by operating the shifting lever with different fingers, the shifting directions are fixed unambiguously and incorrect shifting is practically ruled out. Here it is especially useful when the two pivot axes are arranged at an angle relative to each other, advantageously essentially perpendicular to each other, which also corresponds to the anatomical arrangement of the thumb and index finger.

Because the shifting device according to the invention has only one shifting lever, this device can be manufactured lighter and also more economical.

Other advantageous features of the invention are given from the subordinate claims and the embodiment.

### BRIEF DESCRIPTION OF THE DRAWINGS

Below, one construction of the invention is explained in detail with reference to the drawings.

Shown are:

FIG. 1 an exploded perspective view of a shifting device according to the invention,

FIG. 1a an exploded perspective view of the shifting device from a different perspective,

FIG. 2 a front view of the shifting device in the home position,

FIG. 3 a side view of the shifting device from the right,

FIG. 4 a side view of the shifting device from the left,

FIGS. 5-8 perspective views of the shifting device in various shifting positions, and

FIG. 9 a side view of the shifting device from the left while back-shifting.

### DETAILED DESCRIPTION OF THE PREFERRED EMBODIMENTS

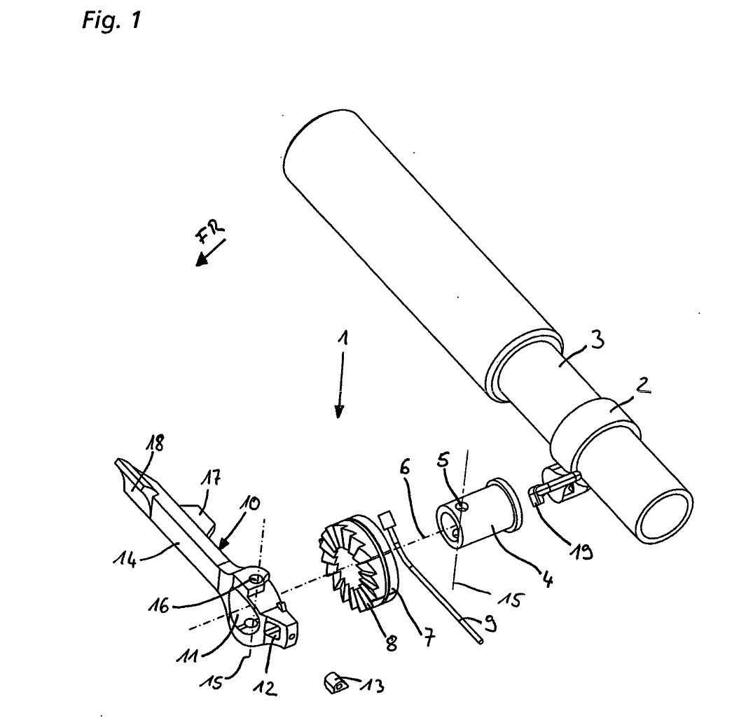

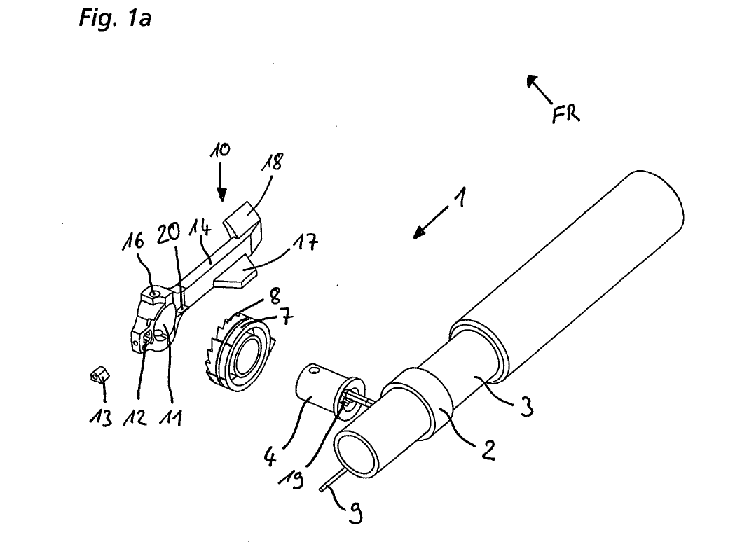

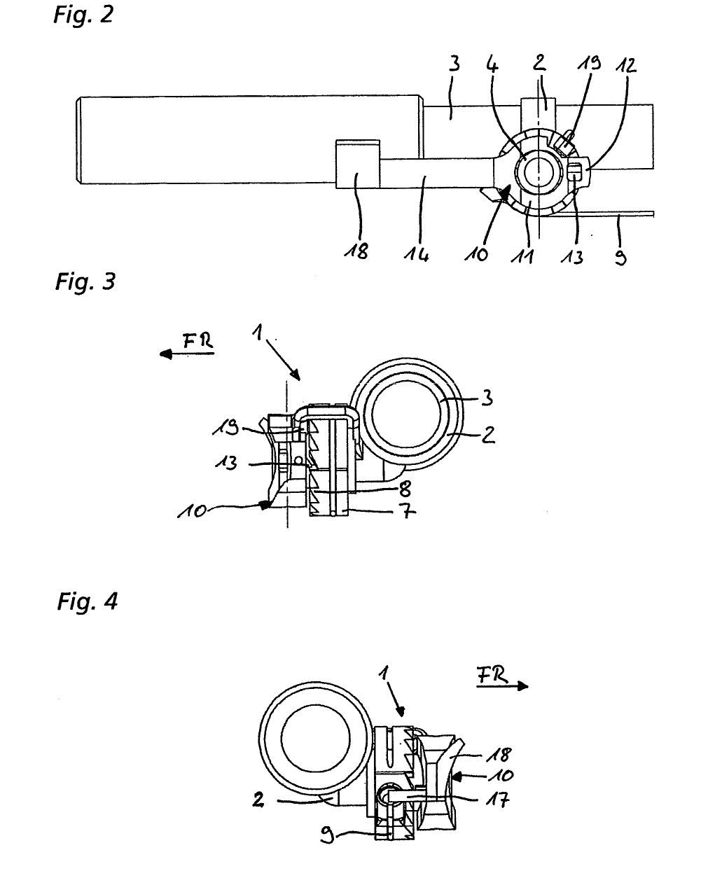

FIG. 1 shows an exploded view of a shifting device according to the invention for a bicycle that is designated as a whole with 1. For better clarity, FIG. 1 is limited to essential components. FIGS. 2 to 4 each show different views of the shifting device, wherein here likewise only essential components are shown. The following description also refers to these figures, if not indicated explicitly.

The shifting device 1 has a mounting clip 2 for assembly on a handlebar 3, wherein the shifting device 1 is mounted essentially in the direction of travel FR. The shown shifting device is thus located on the right on the handlebar 3 and is provided for operation with the right hand in the embodiment.

An axle sleeve 4 is supported so that it can rotate on the mounting clip 2 tangentially and essentially at a right angle to the handlebar 3, wherein the pivot axis 6 of the axle sleeve 4 runs in the direction of travel FR. A crown gear 7 with asymmetric teeth 8 and a central passage opening is arranged so that it can rotate on the axle sleeve 4, so that the teeth 8 point in the direction of travel FR. On the periphery, the crown gear 7 has a receptacle for a Bowden cable 9 by which gear-shifting is controlled. The Bowden cable 9 is held in tension by a restoring spring arranged in the gearshift.

On the axle sleeve 4, a shifting lever 10 is arranged above the crown gear 7, wherein this shifting lever has a passage opening as an axle receptacle 11. A finger lever for operating the shifting device is formed approximately parallel to the handlebar 3 on one side of the axle receptacle 11. On the free end of the finger lever 14 there are gripping surfaces for the thumb 17 and index finger 18 and these gripping surfaces allow ergonomic operation of the finger lever 14.

On the shifting lever 10, a detent-pawl cage 12 with a cam 13 as a detent pawl is arranged on the side of the axle receptacle 11 opposite the finger lever and a fixed detent pawl 20 (FIG. 1a) for engaging in the crown gear 7 is arranged on the side of the axle receptacle 11 facing the finger lever.

The shifting lever 10 is also supported so that it can rotate about a second pivot axis 15 that is essentially perpendicular to the first pivot axis 6. For this purpose, the axle sleeve 4 and the shifting lever 10 have boreholes 5, 16 in the region of the axle receptacle 11, wherein a support bolt connected rigidly to the shifting lever 10 can be inserted into these boreholes.

A second cam 19 for engaging in the crown gear 7 as a detent pawl is supported elastically on the mounting clip 2. The detent pawl can be pivoted out of engagement using a connecting rod by the finger lever 10.

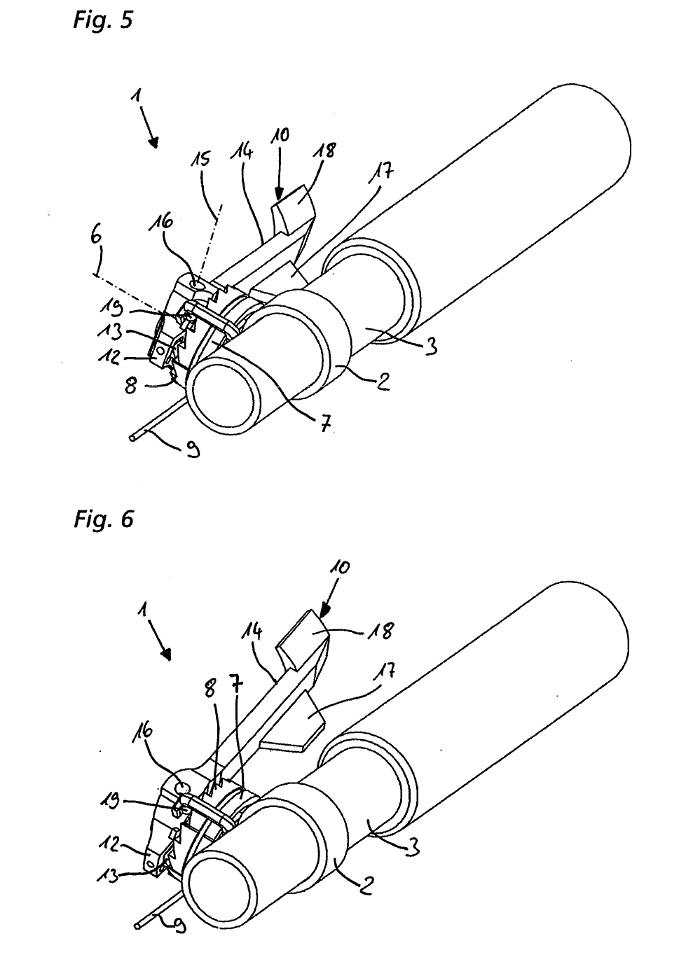

In the home position of the shifting lever 10 shown in FIG. 5, the housing detent-pawl cam 19 engages in the crown gear 7 and thus counteracts the force of the gearshift restoring spring transmitted via the Bowden cable 9.

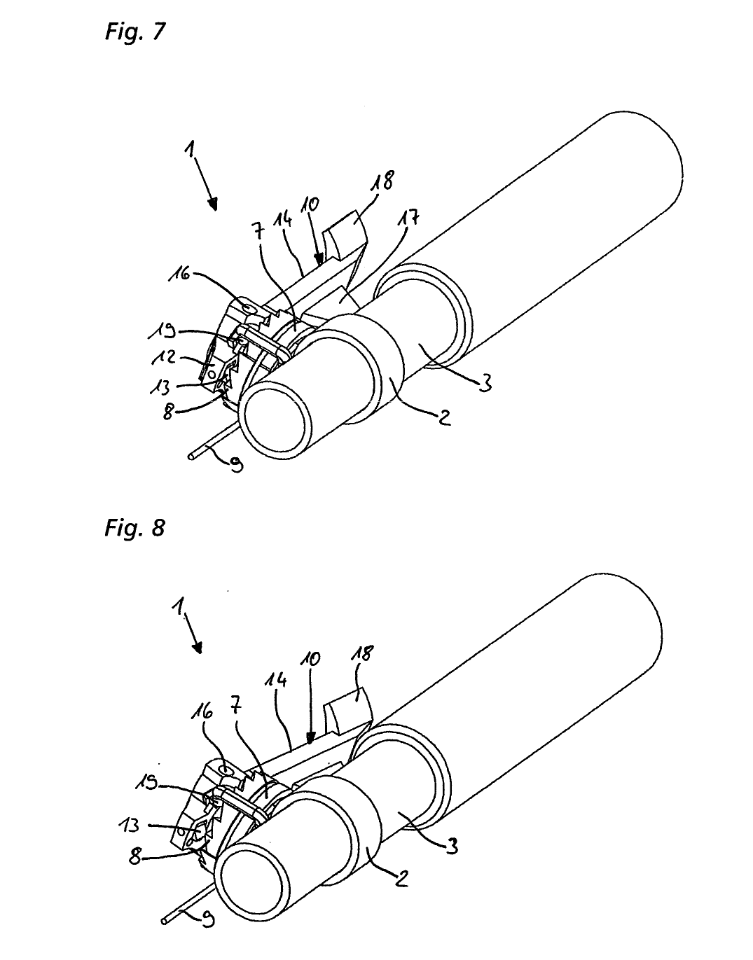

Now if the shifting lever 10 is moved, preferably with the thumb, about the first pivot axis 6 pointing essentially in the direction of travel FR, as shown in FIG. 6, the crown gear 7 is carried along by the engaged shifting lever cam 13. The spring-mounted housing detent-pawl cam 19 here avoids the teeth 8. The Bowden cable 9 attached to the crown gear 7 is therefore set in greater tension and the gearshift is moved to a different gear. When released, the shifting lever 10 returns to its original position with the assistance of springs. The crown gear 7 likewise rotates back until the housing cam 19 locks on the next tooth 8 and blocks the backward motion. Here, the shifting lever cam 13 avoids the teeth 8 elastically. The shifting lever 10 is then located in the original position again, as shown in FIG. 7, but the crown gear 7 is rotated further by one tooth 8. Here it is useful if the teeth intervals are adapted to the shifting path of the gearshift being controlled.

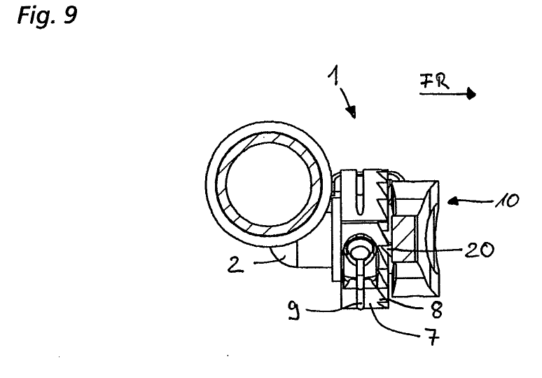

For back-shifting, the shifting lever 10, as shown in FIG. 8, is pulled toward the handlebar 3, that is, pivoted about the second pivot axis 15. Through this rotation of the shifting lever 10, the shifting lever cam 13 is lifted from the engagement region of the teeth 8 of the crown gear 7 and rotated out of engagement of the crown gear 7 by a connecting rod of the housing cam 19. Simultaneously, the cam 20 arranged on the shifting lever 10 and connected rigidly to the lever is brought into an intermediate space between two teeth 8 of the crown gear 7. As soon as two cams 13, 19 are lifted from engagement of the crown gear 7, the crown gear 7 is rotated back about the first pivot axis 6 by the restoring force of the gearshift. This rotation is performed until the shifting lever cam 20 engages in the crown gear 7 (FIG. 9) and this blocks further rotation. The Bowden cable 9 is now somewhat slack but the gearshift is not yet completely returned to the previous gear.

When released, the shifting lever 10 is now set back into its original position by a separate restoring spring. Here, the housing cam 19 is rotated back into an engagement position on the crown gear 7. Then the shifting lever cam 20 is lifted from engagement of the crown gear 7, so that this gear is rotated back by the Bowden cable 9 until it contacts the housing gear 19. The shifting process is thus divided into two phases and is completed only when the shifting lever 10 is released.

1. Shifting device for bicycle gearshifts, comprising an attachment device (2) for installation of the shifting device on a handlebar (3) or similar steering unit, a shifting lever (10) for manual activation that consists of a single shifting lever (10) for both shifting directions, the shifting lever (10) is supported so that it can pivot about two different pivot axes (6, 15), and one shifting direction is allocated to each of the pivot axis (6, 15).

2. Shifting device according to claim 1, wherein the two pivot axes (6, 15) are arranged at an angle relative to each other.

3. Shifting device according to claim 1, wherein the shifting lever (10) or the pivot axes (6, 15) are each arranged for manipulation in the two shifting directions using different fingers of one hand.

4. Shifting device according to claim 1, wherein a crown gear (7) supported so that it can rotate with asymmetric teeth (8) is supported on a first one of the pivot axes, and a Bowden cable (9) is attachable to the crown gear.

5. Shifting device according to claim 1, wherein the shifting lever (10) has a passage opening (11) for receiving one of the two pivot axes (5) and has openings (16) perpendicular to an outer wall for holding a second one of the pivot axes (15).

6. Shifting device according to claim 4, wherein a holder (12) for a detent pawl (13) is arranged on the shifting lever (10) and the detent pawl (13) engages in the crown gear (7) in a locking manner.

7. Shifting device according to claim 6, wherein a detent pawl (19) is supported on the attachment device (2), and the detent pawl engages in a locking manner in the crown gear (7).

8. Shifting device according to claim 4, wherein a stationary cam (20) is arranged on the shifting lever (10) as a detent pawl for engaging in the crown gear (7).

9. Shifting device according to claim 2, wherein the angle equals approximately 90°.
